(19) United States
(12) Patent Application Publication
(10) Pub. No.: US 2012/0233096 A1
(43) Pub. Date: Sep. 13, 2012

(54) OPTIMIZING AN INDEX OF WEB DOCUMENTS

(75) Inventors: ATUL KUMAR GUPTA, Kirkland, WA (US); ANNA V. TIMASHEVA, Mercer Island, WA (US); YUAN WANG, Sammamish, WA (US); RAJKIRAN PANUGANTI, Redmond, WA (US); GARGI GHOSH, Redmond, WA (US); CHAOPING QIN, Cupertino, CA (US); YASSER GANJISAFFAR, Irvine, CA (US); GIRISH KUMAR, Kirkland, WA (US); HONGYAN ZHOU, BOTHELL, WA (US)

(73) Assignee: MICROSOFT CORPORATION, Redmond, WA (US)

(21) Appl. No.: 13/042,016

(22) Filed: Mar. 7, 2011

(51) Int. Cl. G06F 15/18; G06F 17/30

(52) U.S. Cl. 706/12; 707/741; 707/706; 707/E17.002; 707/E17.108

(57) ABSTRACT

Historical usage data related to user queries and training properties for a plurality of web pages is received and utilized to train a mathematical model to predict the likelihood of retrieval of a web page during a web search. Properties are extracted from the plurality of web pages in the index and the mathematical model is applied to the properties for each web page to calculate a sortrank value. The index is reordered based on the sortrank value such that the web pages most likely to be retrieved by a user submitting a search query appear first in the index. After a search query is received from a user the index is traversed in an order determined by the sortrank value. Responsive web pages are presented to the user in an order determined by a search engine ranking algorithm.

### BACKGROUND

In the field of web searching, retrieval time for relevant web documents for a given query often presents a challenge. The task of sifting through billions of web documents and ranking them is a high latency process and demands huge processing resources. The order in which web documents, or web pages, are arranged in an index significantly affects the time it takes for a web search ranker to rank the documents for a given query. Typically a static ranking is assigned to each document that is associated to the quality of each document's links. Unfortunately, this type of ranking is often manipulated by unscrupulous web administrators and does not accurately portray the likelihood that any particular document is more likely to ultimately be retrieved by a user (i.e., web searcher) than another. This is extremely frustrating to the user, because the search engine must traverse the index until relevant documents are identified and ranked and valuable time can be lost. Accordingly, an optimized manner of building an index and ranking documents is needed so that the likelihood of retrieval of documents can be predicted and the search engine can more efficiently return relevant documents.

### SUMMARY

Embodiments of the present invention relate to systems, methods, and computer-readable media for, among other things, optimizing the ranking of documents in an index and efficiently returning relevant documents. In this regard, embodiments of the present invention receive historical usage data related to user queries and training properties for a plurality of web pages. A mathematical model is trained to predict a likelihood of retrieval for the web pages. Properties are extracted from web pages in an index. The mathematical model is applied to the properties. Sortrank values are calculated for web pages based on the mathematical model to reflect the probability of the web pages being retrieved by a user issuing a search query. The index is reordered based on the machine sortrank value. Queries are received from a user and the index is traversed in an order determined by the sortrank value. Documents responsive to the query are retrieved in an order determined by a search engine ranking algorithm.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 schematically shows a computing system architecture suitable for performing embodiments of the invention.

FIG. 3 is a flow diagram showing a method for presenting responsive web pages to a query based on a likelihood of retrieval, in accordance with an embodiment of the present invention; and

FIG. 4 is a flow diagram showing a method for optimizing an index associated with a plurality of web pages, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The following definitions are used to describe properties, training properties, or query independent properties of a web document (or web page) that are used in embodiments of the present invention to optimize an index utilized by a search engine to identify and provide responsive documents. A static rank is used to describe the authority of the documents based on anchor links. A domain rank describes the authority of the domain. A tool bar domain hits counter identifies the number of visits to the domain from the tool bar. A tool bar domain users count identifies the number of unique visitors to the domain from the tool bar. A junk page measure represents a confidence of how likely a document's content does not provide any useful information. A spam page measure represents a confidence of how likely a document and documents that link to it are employing spam tactics. An anchor most frequent count identifies the total frequency of the most frequent terms in the anchor text. A body most frequent count identifies the total frequency of the most frequent terms in the body of the document. An anchor unique phrase count is the number of unique anchor texts pointing to a given document. An anchor total phrase count represents the total number of anchor texts pointing to a given document. An anchor unique term count is the total number of unique terms in anchor text. A body unique term count is the total number of unique terms in the body of the document. A body term count is the total number of terms in the body of the document. A top level domain rating identifies whether the domain is well known, or highly authoritative, domain or not. A words in domain count represents the number of words in the domain portion of a uniform resource locator (URL). A words in path count represents the number of words in the path portion of the URL. A words in title count represents the number of words in the title of a web page. A total anchor count is the number of links pointing to a given web page. A number of entries in the Open Directory Project count identifies the number of entries for a particular web page in the Open Directory Project, located at www.dmoz.org. A tool bar URL hits counter identifies the number of visits to a web page from the tool bar. A tool bar URL users counter identifies the number of unique visitors to the web page from the tool bar.

Embodiments of the present invention relate to systems, methods, and computer storage media having computer-executable instructions embodied thereon that predict the likelihood of selection of web pages during a web search and optimize the retrieval of the web pages while identifying responsive search results. In this regard, embodiments of the present invention perform a processing-friendly, more efficient web search experience. Historical usage data and training properties are utilized to train a mathematical model to predict a likelihood of retrieval for a plurality of web pages in an index. Properties from the plurality of web pages are extracted and the mathematical model is applied to the properties. Sortrank values that reflect the probability of the web pages being retrieved by a user issuing a search query are calculated for each web page and the index is reordered. The web pages are reordered in the index according to the likelihood of retrieval. Accordingly, a query requires less time traversing the index to identify responsive documents that will ultimately be retrieved by the user issuing the query.

Accordingly, in one aspect, the present invention is directed to computer storage media having computer-executable instructions embodied thereon, that when executed, cause a computing device to perform a method for predicting the likelihood of retrieval of web pages during a web search. The method includes receiving historical usage data related to user queries and training properties from the plurality of web pages. A mathematical model is trained to predict a likelihood of retrieval for the plurality of web pages. Properties are extracted from a plurality of web pages in an index. The mathematical model is applied to the properties and a sortrank value is calculated for each web page based on the mathematical model. The index is reordered based on the sortrank value.

In another aspect, the present invention is directed to a computer system, comprising a processor couple to a computer-storage medium, the computer-storage medium having stored thereon a plurality of computer software components executable by the processor for predicting the likelihood of retrieval of web pages during a web search. The computer software components include an extraction component for extracting properties from a plurality of web pages in an index. A ranking component determines a sortrank value for each web page based on the properties. The index is reordered based on the sortrank value by an indexing component.

In yet another aspect, the present invention is directed to a computerized method for optimizing an index of web pages. The method includes receiving historical usage data based on a frequency of document retrieval for a sample query set. A mathematical model is trained with the historical usage data and training properties of web pages to predict a likelihood of retrieval for a plurality of web pages in an index. One or more query independent properties are extracted from the plurality of web pages. A sortrank value is determined by the mathematical model and assigned to each web page. The plurality of web pages in the index is sorted based on the sortrank value.

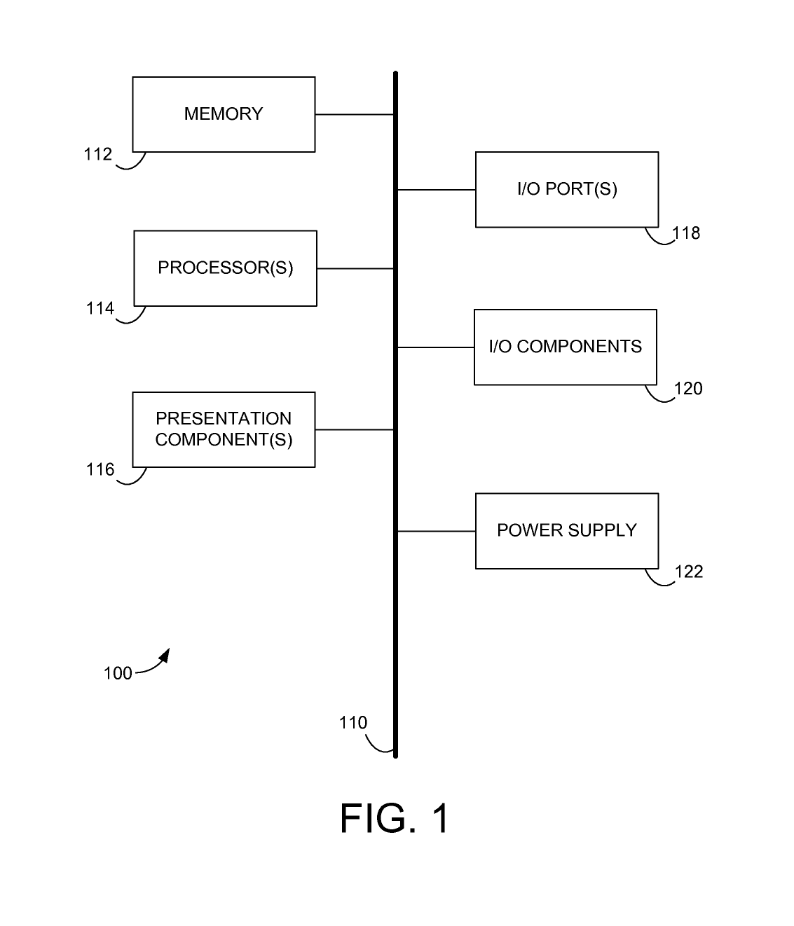

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

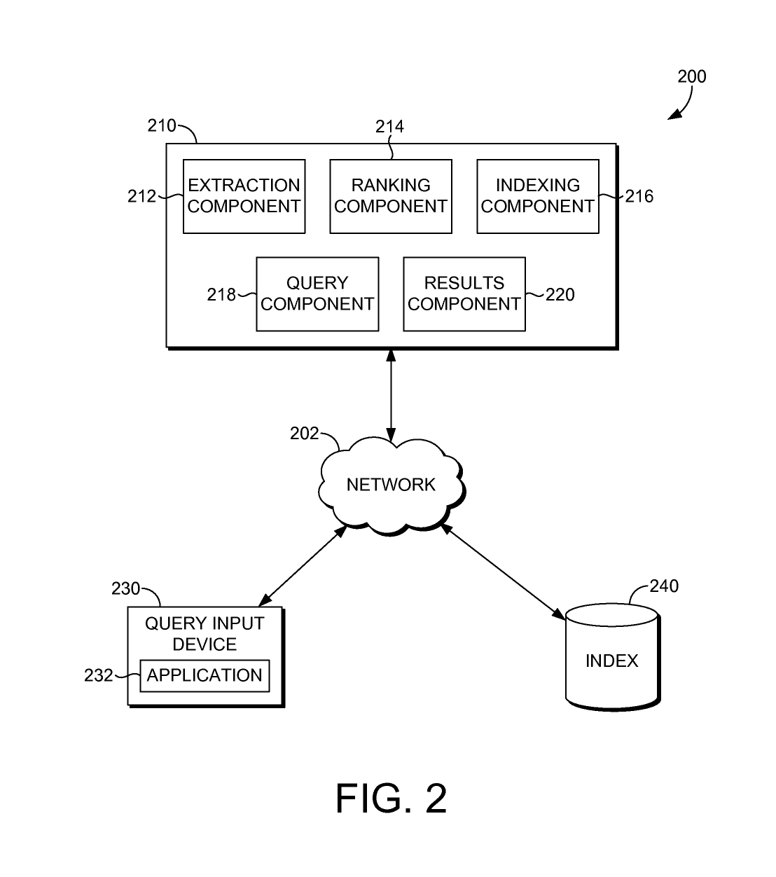

FIG. 2 schematically shows a computing system architecture 200 suitable for performing embodiments of the invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

With continued reference to FIG. 2, the computing system architecture 200 includes a network 202, a search engine server 210, a user device 230, and an index 240. The network 202 includes any computer network such as, for example and not limitation, the Internet, an intranet, private and public local networks, and wireless data or telephone networks.

The query input device 230 is any computing device, such as the computing device 100, capable of running an application 232, from which a search query can be initiated. For example, the query input device 230 might be a personal computer, a laptop, a server computer, a wireless phone or device, a personal digital assistant (PDA), or a digital camera, among others. It should be noted, however, that embodiments are not limited to implementation on such computing devices, but may be implemented on any of a variety of different types of computing devices within the scope of embodiments hereof. In an embodiment, a plurality of query input devices 230, such as thousands or millions of query input devices 230, is connected to the network 202.

The search engine server 210 includes any computing device, such as the computing device 100, and provides at least a portion of the functionalities for providing a search engine. In an embodiment a group of search engine servers 210 share or distribute the functionalities for providing search engine operations to a user population.

Components of the query input device 230 and the search engine server 210 may include, without limitation, a processing unit, internal system memory, and a suitable system bus for coupling various system components, including one or more databases for storing information (e.g., files and metadata associated therewith). Each of the query input device 230 and the search engine server 210 typically includes, or has access to, a variety of computer-readable media.

The search engine server 210 is communicatively coupled to an index 240. The index 240 includes any available computer storage device, or a plurality thereof, such as a hard disk drive, flash memory, optical memory devices, and the like. The index 240 provides a web page index for identifying web documents available via network 202. The index 240 may utilize any indexing data structure or format. When searching for a document associated with a particular query, the index is traversed to identify documents associated with that query. In one embodiment, search results are presented according to a sortrank value associated with the document (i.e., a document with a higher sortrank value is presented higher in the list of search results than a document with a comparatively lower sortrank value). In an embodiment, the search engine server 210 and index 240 directly communicatively coupled so as to allow direct communication between the devices without traversing the network 202.

It will be understood by those of ordinary skill in the art that computing system architecture 200 is merely exemplary. While the search engine server 210 is illustrated as a single unit, one skilled in the art will appreciate that the user data service 210 is scalable. For example, the search engine server 210 may in actuality include a plurality of computing devices in communication with one another. Moreover, the index 240, or portions thereof, may be included within the search engine server 210. The single unit depictions are meant for clarity, not to limit the scope of embodiments in any form.

As shown in FIG. 2, the search engine server 210 includes, among other components, an extraction component 212, a ranking component 214, an indexing component 216, a query component 218, and a results component 220. In one embodiment, a historical component (not shown) receives historical usage data. In various embodiments, the historical usage data comprises data about previous user queries, click analytics, behavioral targeting, geolocation, page tagging, logfile analysis, or a combination thereof. The historical usage data is particularly useful when identifying web pages with a higher probability of retrieval when appearing in search results. The historical usage data is utilized, in one embodiment, by a training component (not shown) for training the ranking component 214. The training component correlates various training properties associated with a plurality of web pages in an index to the historical usage data associated with each web page. This allows the training component to learn what characteristics contribute to the ultimate retrieval of a given web page that appears in search results. A mathematical model (not shown) is of the training process and is utilized by the ranking component 214, as discussed below. In one embodiment, a weighting component (not shown) assigns weight factors to the training properties to influence the amount of weight attributable to each characteristic. As can be appreciated, the training component is dynamic in that it can be taught to evolve to emphasize or deemphasize certain properties to combat questionable tactics that may be utilized by web page administrators to influence that stature of their web page.

The extraction component 212 extracts properties from a plurality of web pages in the index 240. In various embodiments, these properties comprise a static rank, a domain rank, a tool bar domain hit count, a tool bar domain user count, a junk page measure, a spam page measure, an anchor most frequent count, a body most frequent count, an anchor unique phrase count, an anchor total phrase count, an anchor unique term count, a body term count, a top level domain rating, a words in domain count, a words in path count, a words in title count, a total anchor count, a number of entries in the Open Directory Project count, a tool bar uniform resource locator hit count, a tool bar uniform resource locator user count, or any combination thereof. As can be appreciated, many other query independent properties may be extracted from the plurality of web pages.

After the properties are extracted by the extraction component, the ranking component 214 determines a sortrank value for each web page based on the properties. The sortrank value represents the likelihood that the web page will ultimately be retrieved by a user submitting a search query. As discussed above with regard to the training component (not shown), a mathematical model (not shown) is produced which, in one embodiment, directs a weighting component (not shown) to assign weight factors to the various properties to combat questionable tactics that may be utilized by web page administrators to influence that stature of their web page. These weight factors are used by the search engine ranking algorithm (not shown) to determine the sortrank value for each web page.

An indexing component 216 receives the sortrank values for each web page from the ranking component 214. The indexing component reorders the index 240 based on the sortrank values. For example, if the index consisted of five web pages A, B, C, D, and E and based on the traditional link analysis, whereby a web page's rank is largely attributable to the quality of links, the order in the index is determined to be A, B, C, D, and E. However, after analyzing the historical usage data, the training component determines that certain properties of the web pages render the likelihood of actual retrieval of the web pages when presented in search query results to be in the order E, D, C, B, A. The ranking component gives the highest sortrank value to web page E and the lowest sortrank value to web page A, indicating that web page E is the most likely web page to be retrieved and web page A is the least likely web page to be retrieved. The indexing component 216 utilizes the sortrank values to reorder the index as E,D,C,B,A. As can be appreciated, because the internet comprises hundreds of billions of web pages, the efficiency of providing web search results is greatly influenced by the order of the web pages in the index. The resulting reordered index can significantly reduce the time and processing required to traverse the index to build results to a search query that actually contains web pages likely to be retrieved by the user conducting the web search. Experimental results have shown that efficiency is improved by up to 16% when utilizing the reordered index in embodiments of the present invention.

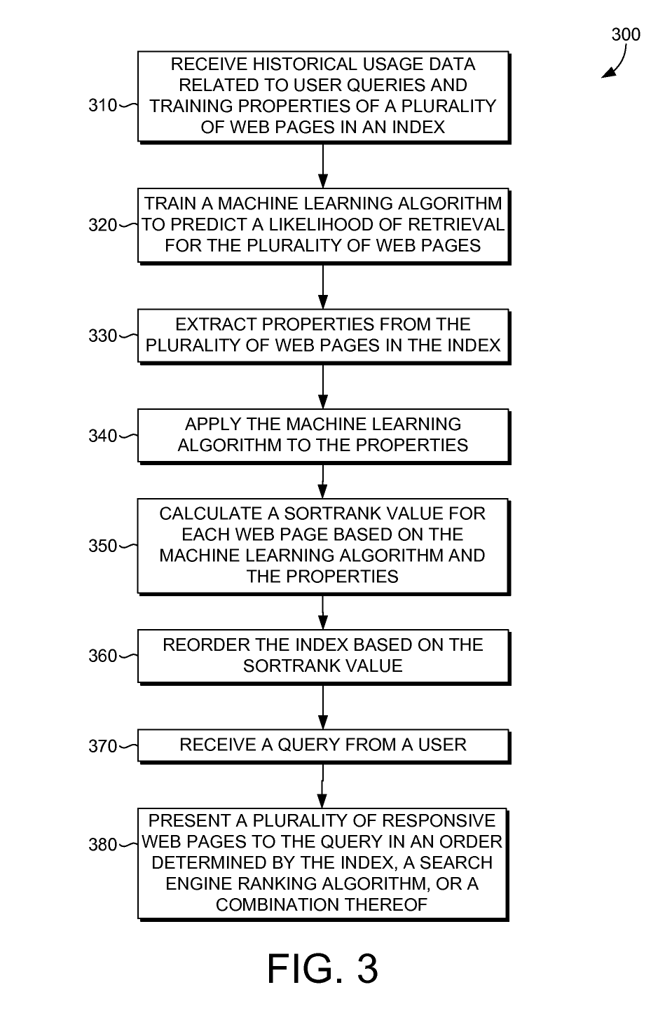

Referring now to FIG. 3, a flow diagram illustrates a method for presenting responsive web pages to a query based on a likelihood of retrieval, in accordance with an embodiment of the present invention. Historical usage data related to user queries and training properties for a plurality of web pages in an index is received at step 310. A mathematical model is trained, at step 320, to predict a likelihood of retrieval for the plurality of web pages. At step 330, properties are extracted from the plurality of web pages in the index. The mathematical model is applied to the properties at step 340. A sortrank value is calculated, at step 350, based on the mathematical model and the properties. At step 360, the index is reordered based on the sortrank value for each web page. A query is received at step 370 and the index is traversed in an order determined by the sortrank value. Responsive web pages are provided, at step 380, in an order determined by the search engine ranking algorithm.

In one embodiment, the historical usage data comprises data about previous user queries, click analytics, behavioral targeting, geolocation, page tagging, logfile analysis, or a combination thereof. The historical usage data trains the mathematical model to identify certain attributes or properties that can predict whether a web page presented as responsive to a search query will ultimately be selected by the user submitting the query. As the mathematical model learns to predict the likelihood that a web page will be retrieved by a user, the mathematical model can be applied to the plurality of web pages in the index.

In one embodiment, the properties extracted from the plurality of web pages comprise a static rank, a domain rank, a tool bar domain hit count, a tool bar domain user count, a junk page measure, a spam page measure, an anchor most frequent count, a body most frequent count, an anchor unique phrase count, an anchor total phrase count, an anchor unique term count, a body term count, a top level domain rating, a words in domain count, a words in path count, a words in title count, a total anchor count, a number of entries in the Open Directory Project count, a tool bar uniform resource locator hit count, a tool bar uniform resource locator user count, or a combination thereof. In one embodiment, the mathematical model utilizes a weight factor assigned to each property to signify an importance of the property when calculating the sortrank value. For example, the mathematical model may determine, based on the historical usage data, that one specific property has been exploited by web administrators to circumvent the current ranking system and achieve better positioning in search results than may be warranted. The mathematical model may adapt to these tactics and deemphasize the importance of that particular property or increase the importance of another more reliable property. This can be achieved because the mathematical model is able to adapt and respond to these situations.

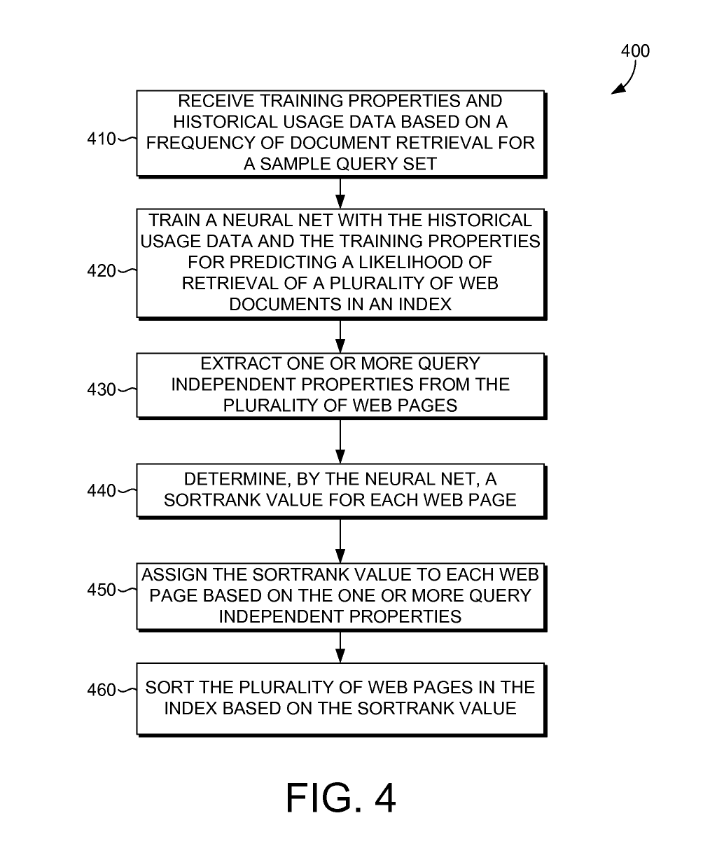

Referring now to FIG. 4, a flow diagram illustrates a method for optimizing an index associated with a plurality of web pages, in accordance with an embodiment of the present invention. At step 410, training properties and historical usage data based on a frequency of document retrieval for a sample query set is received. A mathematical model is trained, at step 420, with the historical usage data and training properties to predict the likelihood of retrieval of a plurality of web documents in an index. One or more query independent properties are extracted from the plurality of web pages at step 430. The mathematical model determines, at step 440, a sortrank value for each web page.

In one embodiment, a sortrank value is assigned to each web page based on the one or more properties. The plurality of web pages are sorted in the index based on the sortrank value. In one embodiment, a query is received and responsive web pages are identified. In one embodiment, the responsive web pages are presented, based on the location of each responsive web page in the index. For example, the responsive web pages most likely to be retrieved by a user have the highest sortrank value and appear at the top of the index. These responsive web pages will appear first in the search results. Those with a lower sortrank value appear lower in the index, indicating those web pages are less likely to be retrieved by a user.

In one embodiment, the historical usage data comprises data about previous user queries, click analytics, behavioral targeting, geolocation, page tagging, logfile analysis, or a combination thereof. The historical usage data is utilized to train the mathematical model to identify certain characteristics that can predict whether a web page is likely to be retrieved by a user submitting a search query. The mathematical model may identify certain characteristics that are more important than others in determining the likelihood of retrieval. Accordingly, the mathematical model may assign weight factors to different training properties to better predict the likelihood of retrieval.

In one embodiment, the one or more properties extracted from the plurality of web pages comprise a static rank, a domain rank, a tool bar domain hit count, a tool bar domain user count, a junk page measure, a spam page measure, an anchor most frequent count, a body most frequent count, an anchor unique phrase count, an anchor total phrase count, an anchor unique term count, a body term count, a top level domain rating, a words in domain count, a words in path count, a words in title count, a total anchor count, a number of entries in the Open Directory Project count, a tool bar uniform resource locator hit count, a tool bar uniform resource locator user count, or a combination thereof. In one embodiment, the mathematical model assigns weight factors algorithm utilizes to the one or more properties to signify the importance of each individual property when calculating the sortrank value. The mathematical model may determine based on the historical usage data, that one specific property does not accurately predict the likelihood of retrieval. The mathematical model can reduce the effect of that particular property on the sortrank value or increase the effect of another more reliable property to calculate an updated sortrank value. Thus, although the index may be regarded as static in terms of its disregard for the content of the search query, it is actually dynamic and able to adapt to changes necessitating a reordering of the index (e.g. spam web pages, unscrupulous web administrators, etc.).

It will be understood by those of ordinary skill in the art that the order of steps shown in the method 300 and 400 of FIGS. 3 and 4 respectively are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media (the “media”) storing computer-useable instructions that, when used by one or more computing devices, cause the one or more computing devices to perform a method for predicting the likelihood of retrieval of web documents during a web search, the method comprising:
receiving historical usage data related to user queries and training properties of a plurality of web pages in an index;
training a mathematical model to predict a likelihood of retrieval for the plurality of web pages based on the historical usage data and the training properties;
extracting properties from the plurality of web pages in the index;
applying the mathematical model to the properties;
calculating a sortrank value for each web page based on the mathematical model and the properties;
reordering the index based on the sortrank value for each web page;

2. The media of claim 1 further comprising:
receiving a query from a user;
traversing the index in an order determined by the sortrank value; and
presenting responsive web pages in an order determined by a search engine ranking algorithm.

3. The media of claim 1, wherein the historical usage data comprises data about previous user queries, click analytics, behavioral targeting, geolocation, page tagging, logfile analysis, or a combination thereof.

4. The media of claim 1, wherein the properties are query independent.

5. The media of claim 1, wherein the properties comprise a static rank, a domain rank, a tool bar domain hit count, a tool bar domain user count, a junk page measure, a spam page measure, an anchor most frequent count, a body most frequent count, an anchor unique phrase count, an anchor total phrase count, an anchor unique term count, a body term count, a top level domain rating, a words in domain count, a words in path count, a words in title count, a total anchor count, a number of entries in the Open Directory Project count, a tool bar uniform resource locator hit count, a tool bar uniform resource locator user count, or a combination thereof.

6. The media of claim 1, wherein the mathematical model utilizes a weight factor assigned to each property to signify an importance of the property when calculating the sortrank value.

7. A computer system for predicting the likelihood of retrieval of web documents during a web search, the computer system comprising a processor coupled to a computer-storage medium, the computer-storage medium having stored thereon a plurality of computer software components executable by the processor, the computer software components comprising:
an extraction component for extracting properties from a plurality of web pages in an index;
a ranking component for determining a sortrank value for each web page based on the properties; and
an indexing component for reordering the index based on the sortrank value;

8. The system of claim 7, further comprising:
a query component for receiving a query from a user;
traversing the index in an order determined by the sortrank value; and
a results component for identifying responsive web pages to the query in an order determined by a search engine ranking algorithm.

9. The computer system of claim 7, wherein the properties comprise a static rank, a domain rank, a tool bar domain hit count, a tool bar domain user count, a junk page measure, a spam page measure, an anchor most frequent count, a body most frequent count, an anchor unique phrase count, an anchor total phrase count, an anchor unique term count, a body term count, a top level domain rating, a words in domain count, a words in path count, a words in title count, a total anchor count, a number of entries in the Open Directory Project count, a tool bar uniform resource locator hit count, a tool bar uniform resource locator user count, or a combination thereof.

10. The computer system of claim 7, further comprising a training component for training the ranking component.

11. The computer system of claim 10, further comprising a historical component for receiving historical usage data.

12. The computer system of claim 11, wherein the training component utilizes the historical usage data and training properties associated with a sample of web pages in the index for training the ranking component.

13. The computer system of claim 11, wherein the historical usage data comprises data about previous user queries, click analytics, behavioral targeting, geolocation, page tagging, logfile analysis, or a combination thereof.

14. The computer system of claim 7, further comprising a weighting component for assigning weight factors to the properties.

15. A computerized method for predicting the likelihood of retrieval of web documents, the method comprising:
receiving historical usage data based on a frequency of web page retrieval for a sample query set;
training a mathematical model with the historical usage data and training properties of web pages to predict a likelihood of retrieval;
extracting one or more query independent properties from a plurality of web pages in an index;
determining, by the mathematical model, a sortrank value for each web page;
assigning the sortrank value to each web page based on the one or more query independent properties; and
sorting the plurality of web pages in the index based on the sortrank value.

16. The method of claim 15, wherein the historical usage data comprises data about previous user queries, click analytics, behavioral targeting, geolocation, page tagging, logfile analysis, or a combination thereof.

17. The method of claim 15, wherein the properties comprise a static rank, a domain rank, a tool bar domain hit count, a tool bar domain user count, a junk page measure, a spam page measure, an anchor most frequent count, a body most frequent count, an anchor unique phrase count, an anchor total phrase count, an anchor unique term count, a body term count, a top level domain rating, a words in domain count, a words in path count, a words in title count, a total anchor count, a number of entries in the Open Directory Project count, a tool bar uniform resource locator hit count, a tool bar uniform resource locator user count, or any combination thereof.

18. The method of claim 17, wherein the properties are assigned a weight factor.

19. The method of claim 15, further comprising receiving a query and retrieving responsive web pages.

20. The method of claim 19, further comprising traversing the index in an order determined by the sortrank value and displaying the responsive web pages in an order determined by a search engine ranking algorithm.
